(19) United States
(12) Patent Application Publication
(10) Pub. No.: US 2019/0318240 A1
(43) Pub. Date: Oct. 17, 2019

(54) TRAINING MACHINE LEARNING MODELS IN DISTRIBUTED COMPUTING SYSTEMS

(71) Applicant: KAZUHM, INC., San Diego, CA (US)

(72) Inventors: Rounak Prasad KULKARNI, San Diego, CA (US); Armin KADIYAN, Solana Beach, CA (US); Tim O'NEAL, Carlsbad, CA (US)

(21) Appl. No.: 16/154,562

(22) Filed: Oct. 8, 2018

Related U.S. Application Data
(60) Provisional application No. 62/658,521, filed on Apr. 16, 2018.

(51) Int. Cl. G06N 3/08; G06N 3/04; G06K 9/62; G06F 9/455; G06F 15/18

(52) U.S. Cl. CPC G06N 3/08; G06N 3/04; G06F 15/18; G06F 9/455; G06K 9/6256

(57) ABSTRACT

Certain aspects of the present disclosure provide methods and systems for training a machine learning model, such as a neural network or deep learning model, in a distributed computing system. In some embodiments, aspects of the machine learning model are trained within containers distributed amongst nodes in the distributed computing environment.

### CROSS-REFERENCE TO RELATED APPLICATIONS

This application claims priority to U.S. Provisional Patent Application No. 62/658,521, filed on Apr. 16, 2018, which is incorporated herein by reference in its entirety.

### INTRODUCTION

Aspects of the present disclosure relate to systems and methods for performing data processing on distributed computing resources.

Computing is increasingly ubiquitous in modern life, and the demand for computing resources is increasing at a substantial rate. Organizations of all types are finding reasons to analyze more and more data to their respective ends.

Many complimentary technologies have changed the way data processing is handled for various users and organizations. For example, improvements in networking performance and availability (e.g., via the Internet) have enabled organizations to rely on cloud-based computing resources for data processing rather than building out dedicated, high-performance computing infrastructure to perform the data processing. The promise of cloud-based computing resource providers is that such resources are cheaper, more reliable, easily scalable, and such resources do not require any high-performance on-site computing equipment. Unfortunately, the various promises relating to cloud-based computing have not all come to fruition. In particular, the cost of cloud-based computing resources has turned out in many cases to be as or even more expensive than building dedicated on-site hardware for data processing needs. Moreover, cloud-based computing exposes organizations to certain challenges and risks, such as data custody and privacy.

Many organizations have significant amounts of non-dedicated and/or non-special purpose processing resources, which are rarely used anywhere near their processing capacity. However, such organizations are generally not able to leverage all of their existing computing resources for processing intensive tasks. Rather, each of the organization's general purpose processing resources is generally used only for general purpose tasks. Clearly, such organizations would significantly benefit from leveraging the non-dedicated and/or non-special purpose computing resources in an orchestrated fashion for processing intensive tasks, such as for training machine learning models.

In particular, neural network models trained on large data sets can obtain impressive performance across a wide variety of domains, including speech and image recognition, natural language processing, fraud and intrusion detection, and decision systems, to name but a few. But training such neural network models is computationally demanding, and even with steady improvements in processing capabilities and training methods, training on single machines—even when purpose built and powerful—can take an impractically long time.

Accordingly, systems and methods are needed to enable organizations to leverage general purpose computing resources for distributed data processing, such as for training complex machine learning models.

### BRIEF SUMMARY

Certain embodiments provide a method for training a machine learning model in a distributed computing system. In one implementation, the method includes: receiving a model training request; receiving a training data set; determining a processing node available in a distributed computing system; receiving static status information regarding the processing node; causing a first container to be installed at the processing node based on the static status information, the first container being configured with a model training application; causing a second container to be installed at the processing node based on the static status information, the second container being configured with the model training application; assigning a first layer of a model to be trained by the model training application in the first container; assigning a second layer of the model to be trained by the model training application in the second container; receiving parameter data from the model training application in the first container, the model training application in the second container, and the model training application in the third container; and calculating a model parameter based on the parameter data.

Other embodiments provide a non-transitory computer-readable medium comprising instructions to perform the method for training a machine learning model in a distributed computing system. Further embodiments provide an apparatus configured to perform the method for training a machine learning model in a distributed computing system.

The following description and the related drawings set forth in detail certain illustrative features of one or more embodiments.

### BRIEF DESCRIPTION OF THE DRAWINGS

The appended figures depict certain aspects of the one or more embodiments and are therefore not to be considered limiting of the scope of this disclosure.

FIG. 1 depicts an embodiment of a heterogeneous distributed computing resource management system.

FIG. 2 depicts an example of a resource pool of a heterogeneous distributed computing resource management system.

FIG. 3 depicts an example of a container of a heterogeneous distributed computing resource management system.

FIG. 4 depicts an example method that may be performed by a heterogeneous distributed computing resource management system.

FIG. 5A depicts an example of model parallelism for training a machine learning model.

FIG. 5B depicts an example of data parallelism for training a machine learning model.

FIG. 5C depicts an example of hybrid model parallelism/data parallelism for training a machine learning model.

FIG. 6 depicts aspects of a distributed computing system configured for distributed training of machine learning models.

FIG. 7 depicts a method for training a machine learning model in a distributed computing system.

FIG. 8 depicts a processing system 800 that may be used to perform methods described herein.

To facilitate understanding, identical reference numerals have been used, where possible, to designate identical elements that are common to the drawings. It is contemplated that elements and features of one embodiment may be beneficially incorporated in other embodiments without further recitation.

### DETAILED DESCRIPTION

Aspects of the present disclosure provide apparatuses, methods, processing systems, and computer readable mediums for leveraging general purpose computing resources for distributed data processing, such as for training complex machine learning models.

Organizations have many types of computing resources that may go underutilized during every day. Many of these computing resources (e.g., desktop and laptop computers) are significantly powerful despite being general-use resources. Thus, a distributed computing system that can unify these disparate computing resources into a high-performance computing environment may provide several benefits, including: a significant decrease in cost of processing organization workloads, and a significant increase in the organization's ability to protect information related to the processing of workloads by processing those workloads on-site in organization-controlled environments. In fact, for some organizations, such as those that deal with sensitive information, on-site processing is the only option because sensitive information may not be allowed to be processed using off-site computing resources, such as cloud-based resources.

Described herein is a cross-platform system of components necessary to unify computing resources in a manner that efficiently processes organizational workloads—without the need for special-purpose on-site computing hardware, or reliance on off-site cloud-computing resources. This unification of computing resources can be referred to as distributed computing, peer computing, high-throughput computing (HTC), or high-performance computing (HPC). Further, because such a cross-platform system may leverage many types of computing resources within a single, organized system, the system may be referred to as a heterogeneous distributed computing resource management system. The heterogeneous distributed computing systems and methods described herein may be used by organizations to handle significant and complex data processing loads, such as training machine learning models, and in training particular neural-networks and performing deep learning.

One aspect of a heterogeneous distributed computing resource management system is the use of containers across the system of heterogeneous computing resources. A distributed computing system manager may orchestrate containers, applications resident in those containers, and workloads handled by those applications in a manner that delivers maximum performance and value to organizations simultaneously. For example, such a system may be used to distribute processing related to the training of complex machine learning models, such as neural networks and deep learning models.

There are many advantages of a heterogeneous distributed computing resource management system as compared to the conventional solutions described above. For example, on-site purpose-built hardware rapidly becomes obsolete in performance and capability despite the high-cost of designing, installing, operating, and maintaining such systems. Such systems tend to require homogeneous underlying equipment and tend not to be capable of interacting with other computing resources that are not likewise purpose-built. Further, such systems are not easily upgradeable. Rather, they tend to require extensive and costly overhauls on long intervals meaning that in the time between major overhauls, those systems slowly degrade in their relative performance. By contrast, the heterogeneous distributed computing resource management system described herein can leverage any sort of computing device within an organization through the use of the containers. Because such computing devices are more regularly turned over (e.g., replaced with newer devices), the capability of the system as a whole is continually increasing, but without any special purpose organizational spend. For example, every time a general purpose desktop workstation, laptop, or server is replaced, its improved capabilities are made available to the distributed system.

Another significant advantage is increasing the utilization of existing computing resources. The average general-purpose desktop workstation or laptop is significantly more powerful than what it is regularly used for. In other words, internet browsing, word processing applications, email, etc., do not even come close in most cases to utilizing the full potential of these computing resources. This is true of servers and special purposes machines as well. Servers rarely run at their actual capacity, and special purpose computers (e.g., high-end graphic rendering computers) may only be used for one third or less of a day (e.g., during the workday) at anywhere near their capacity. The ability to utilize the vast number and capability of existing organizational computing resources means that an organization can accomplish much more without having to buy more computing resources, upgrade existing computing resources, rely solely on cloud-based computing resources, etc.

Yet another advantage of a heterogeneous distributed computing resource management system is reducing single points of failure from the system. For example, in a dedicated system or when relying solely on a cloud-based computing service, an organization is at operational risk of the dedicated system or cloud-based computing service going down. When instead relying on a distributed group of computing resources, the failure of any one, or even several resources, will only have a marginal impact on the distributed system as a whole. That is, a heterogeneous distributed computing resource management system is more fault tolerant than dedicated systems or cloud-based computing services from the organization's perspective.

### Example Heterogeneous Distributed Computing Resource Management System

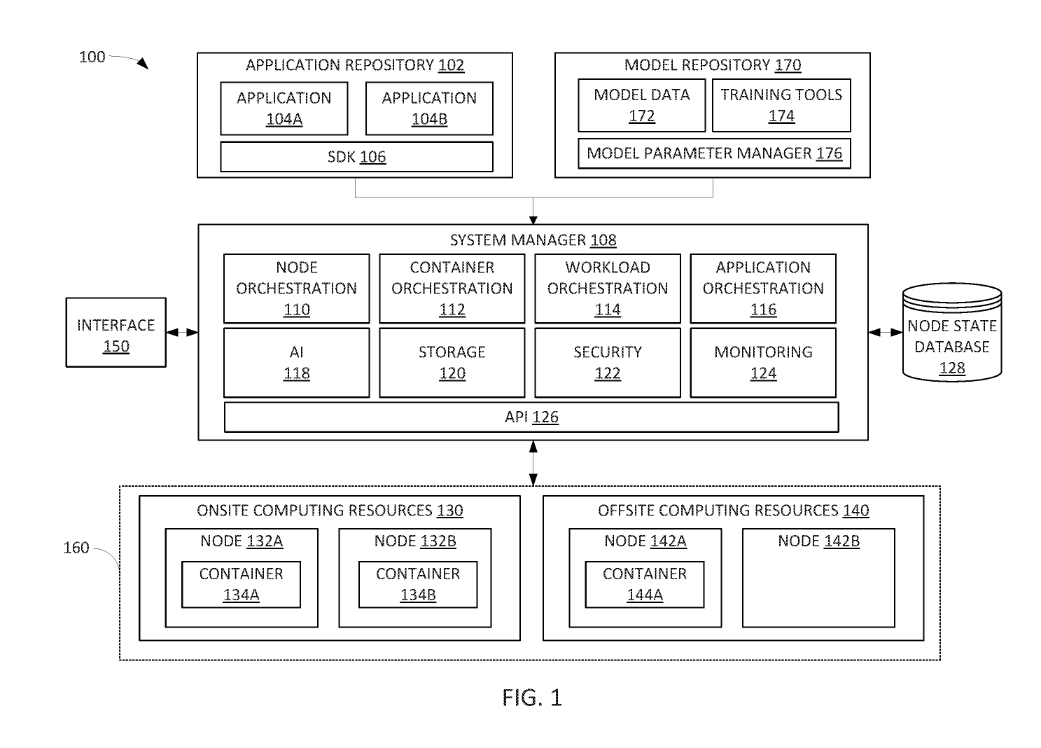

FIG. 1 depicts an embodiment of a heterogeneous distributed computing resource management system 100.

Management system 100 includes an application repository 102. Application repository 102 stores and makes accessible applications, such as applications 104A-D. Applications 104A-B may be used by system 100 in containers deployed on remote resources managed by management system 100, such as containers 134A, 134B, and 144A. In some examples, application repository 102 may act as an application marketplace for developers to market their applications.

Application repository includes a software development kit (SDK) 106, which may include a set of software development tools that allows the creation of applications (such as applications 104A-B) for a certain software package, software framework, hardware platform, computer system, video game console, operating system, or similar development platform. SDK 106 allows software developers to develop applications (such as applications 104A-104B), which may be deployed within management system 100, such as to containers 134A, 134B, and 144A.

Some SDKs are critical for developing a platform-specific application. For example, the development of an Android app on Java platform requires a Java Development Kit, for iOS apps the iOS SDK, for Universal Windows Platform the .NET Framework SDK, and others. There are also SDKs that are installed in apps to provide analytics and data about activity. In some cases, and SDK may implement one or more application programming interfaces (APIs) in the form of on-device libraries to interface to a particular programming language, or to include sophisticated hardware that can communicate with a particular embedded system. Common tools include debugging facilities and other utilities, often presented in an integrated development environment (IDE). Note, though shown as a single SDK 106 in FIG. 1, SDK 106 may include multiple SDKs.

Management system 100 also includes system manager 108. System manager 108 may alternatively be referred to as the “system management core” or just the “core” of management system 100. System manager 108 includes many modules, including a node orchestration module 110, container orchestration module 112, workload orchestration module 114, application orchestration module 116, AI module 118, storage module 120, security module 122, and monitoring module 124. Notably, in other embodiments, system manager 108 may include only a subset of the aforementioned modules, while in yet other embodiments, system manager 108 may include additional modules. In some embodiments, various modules may be combined functionally.

Node orchestration module 110 is configured to manage nodes associated with management system 100. For example, node orchestration module 110 may monitor whether a particular node is online as well as status information associated with each node, such as what the processing capacity of the node is, what the network capacity of the node is, what type of network connection the node has, what the memory capacity of the node is, what the storage capacity of the node is, what the battery power of the node is (if it is a mobile node not running on batter power), etc. Node orchestration module 110 may share status information with artificial intelligence (AI) module 118. Node orchestration module 110 may receive messages from nodes as they come online in order to make them available to management system 100 and may also receive status messages from active nodes in the system.

Node orchestration module 110 may also control the configuration of certain nodes according to predefined node profiles. For example, node orchestration module 110 may assign a node (e.g., 132A, 132B, or 142A) as a processing node, a storage node, a security node, a monitoring node, or other types of nodes.

A processing node may generally be tasked with data processing by management system 100. As such, processing nodes may tend to have high processing capacity and availability. Processing nodes may also tend to have more applications installed in their respective containers compared to other types of nodes. In some examples, processing nodes may be used for training models, such as complex machine learning models, including neural network and deep learning models.

A storage node may generally be tasked with data storage. As such, storage nodes may tend to have high storage availability.

A security node may be tasked with security related tasks, such as monitoring activity of other nodes, including nodes in common sub-pool of resources, and reporting that activity back to security module 122. A security node may also have certain, security related types of applications, such as virus scanners, intrusion detection software, etc.

A monitoring node may be tasked with monitoring related tasks, such as monitoring activity of other nodes, including nodes in a common sub-pool of resources, and reporting that activity back to node orchestration module 110 or monitoring module 124. Such activity may include the nodes availability, the nodes connection quality, and other such data.

Not all nodes need to be a specific type of node. For example, there may be general purpose nodes that include capabilities associated with one or more of processing, storage, security, and monitoring. Further, there may be other specific types of nodes, such as machine learning model training or execution nodes.

Container orchestration module 112 manages the deployment of container to various nodes, such as containers 134A, 134B, and 144A to nodes 132A, 132B, and 142A, respectively. For example, container orchestration module 112 may control the installation of containers in nodes, such as 142B, which are known to management system 100, but which do not yet have containers. In some cases, container orchestration module 112 may interact with node orchestration module 110 and/or monitoring module 124 to determine the status of various containers on various nodes associated with system 100.

Workload orchestration module 114 is configured to manage workloads distributed to various nodes, such as nodes 132A, 132B, and 142A. For example, when a job is received by management system 100, for example by way of interface 150, workload orchestration module 114 may distribute the job to one or more nodes for processing. In particular, workload orchestration module 114 may receive node status information from node orchestration module 110 and distribute the job to one or more nodes in such a way as to optimize processing time and maximize resources utilization based on the status of the nodes connected to the system.

In some cases, when a node becomes unavailable (e.g., goes offline) or become insufficiently available (e.g., does not have adequate processing capacity), workload orchestration module 114 will reassign the job to one or more other nodes. For example, if workload orchestration module 114 had initially assigned a job to node 132A, but then node 132A went offline, then workload orchestration module 114 may reassign the job to node 132B. In some cases, the reassignment of a job may include the entire job, or just a portion of a job that was not yet completed by the original assigned node.

Workload orchestration module 114 may also provide splitting (or chunking) operations. Splitting or chunking is the act of breaking a large processing job down in to small parts that can be processed by multiple processing nodes at once (i.e., in parallel). Notably, workload orchestration may be handled by system manager 108 as well as by one or more nodes. For example, an instance of workload orchestration module 114 may be loaded onto a node to manage workload within a sub-pool of resources in a peer-to-peer fashion in case access to system manager 108 is not always available.

Workload orchestration module 114 may also include scheduling capabilities. For example, schedules may be configured to manage computing resources (e.g., nodes 132A, 132B, and 142A) according to custom schedules to prevent resource over-utilization, or to otherwise prevent interruption with a nodes primary purpose (e.g., being an employee workstation).

In one example, a node may configure such that it can be used by system 100 only during certain hours of the day. In some cases, multiple levels of resource management may be configured. For example, a first percentage of processing resources at a given node may be allowed during a first time interval (e.g., during working hours) and a second percentage of processing resources may be allowed during a second time interval (e.g., during non-working hours). In this way, the nodes can be configured for maximum resource utilization without negatively affecting end-user experience with the nodes during regular operation (i.e., operation unrelated to system 100). In some cases, schedules may be set through interface 150.

In the example depicted in FIG. 1, workload orchestration module 114 is a part of system manager 108, but in other examples an orchestration module may be resident on a particular node, such as node 132A, to manage the resident node's resources as well as other node's resources in a peer-to-peer management scheme. This may allow, for example, jobs to be managed by a node locally while the node moves in and out of connectivity with system manager 108. In such cases, the node-specific instantiation of a node orchestration module may nevertheless be a “slave” to the master node orchestration module 110.

Application orchestration module 116 manages which applications are installed in which containers, such as containers 134A, 134B, and 144A. For example, workflow orchestration module 114 may assign a job to a node that does not currently have the appropriate application installed to perform the job. In such a case, application orchestration module 116 may cause the application to be installed in the container from, for example, application repository 102.

Application orchestration module 116 is further configured to manage applications once they are installed in containers, such as in containers 134A, 134B, and 144A. For example, application orchestration module 116 may enable or disable applications installed in containers, grant user permissions related to the applications, and grant access to resources. Application orchestration module 116 enables a software developer to, for example, upload new applications, remove applications, manage subscriptions associated with applications, and receive data regarding applications (e.g., number of downloads, installs, active users, etc.) in application repository 102, among other things.

In some examples, application orchestration module 116 may manage the initial installation of applications (such as 104A-104D) in containers on nodes. For example, if a container was installed in node 142B, application orchestration module 116 may direct an initial set of applications to be installed on node 142B. In some cases, the initial set of applications to be installed on a node may be based on a profile associated with the node. In other cases, the initial set of applications may be based on status information associated with the node (such as collected by node orchestration module 110). For example, if a particular node does not regularly have significant unused processing capacity, application orchestration module 116 may determine not to install certain applications that require significant processing capacity.

Like workload orchestration module 114, in some cases application orchestration module 116 may be installed on a particular node to manage deployment of applications in a cluster of nodes. As above, this may reduce reliance on system manager 108 in situations such as intermittent connectivity. And as with the workload orchestration module 114, a node-specific instantiation of an application orchestration module may be a slave to a master application orchestration module 116 running as part of system manager 108.

AI module 118 may be configured to interact with various aspects of management system 100 (e.g., node orchestration module 110, container orchestration module 112, workload orchestration module 114, application orchestration module 116, storage module 120, security module 122, and monitoring module 124) in order to optimize the performance of management system 100. For example, AI module 118 may monitor performance characteristics associated with various nodes and feedback workload optimizations to workload orchestration module 114. Likewise, AI module 118 may monitor network activity between various nodes to determine aberrations in the network activity and to thereafter alert security module 122.

AI module 118 may include a variety of machine-learning models in order to analyze data associated with management system 100 and to optimize its performance. AI module 118 may further include data preprocessing and model training capabilities for creating and maintaining machine learning models.

Storage module 120 may be configured to manage storage nodes associated with management system 100. For example, storage module 120 may monitor status of storage allocations, both long-term and short-term, within management system 100. In some cases, storage module 120 may interact with workload orchestration module 114 in order to distribute data associated with jobs, or portions of jobs to various nodes for short-term or long-term storage. Further, storage module 120 may report such status information to application orchestration module 116 to determine whether certain nodes have enough storage to available for certain applications to be installed on those nodes. Storage information collected by storage module 120 may also be shared with AI module 118 for use in system optimization.

Security module 122 may be configured to monitor management system 100 for any security breaches, such as unauthorized attempts to access containers, unauthorized job assignment, etc. Security module 122 may also manage secure connection generation between various nodes (e.g., 132A, 132B, and 142A) and system manager 108. In some cases, security module 122 may also handle user authentication, e.g., with respect to interface 150. Further, security module 122 may provide connectivity back to enterprise security information and event management (STEM) software through, for example, application programming interface (API) 126.

In some cases, security module 122 may observe secure operating behavior in the environment and make necessary adjustments if a security situation is observed. For example, security module 122 may use machine learning, advanced statistical analysis, and other analytic methods to flag potential security issues within management system 100.

Monitoring module 124 may be configured to monitor the performance of management system 100. For example, monitoring module 124 may monitor and record data regarding the performance of various jobs (e.g., how long the job took, how many nodes were involved, how much network traffic the job created, what percentage processing capacity was used at a particular node, and others. Monitoring module may generate analytics based on the performance of system 100 and share them with other aspects. For example, monitoring module 124 may provide the monitoring information to AI module 118 to further enhance system performance. As another example, the analytics may be displayed in interface 150 so a system user may determine system performance and potentially change various parameters of system 100. In other embodiments, there may be a separate analytics module (not depicted) that is focused on the generation of analytics for system 100.

Monitoring module 124 may also provide the monitoring data to interface 150 in order to display system performance metrics to a user. For example, the monitoring data may be useful to report key performance indicators (KPIs) on a user dashboard.

Application programming interface (API) 126 may be configured to allow any of the aforementioned modules to interact with nodes (e.g., 132A, 132B, and 142A) or containers (e.g., 134A, 134B, or 144A). Further, API 126 may be configured to connect third-party applications and capabilities to management system 100. For example, API 126 may provide a connection to third-party storage systems, such as AMAZON 53®, EGNYTE®, and DROPBOX®, among others.

Management system 100 includes a pool of computing resources 160. The computing resources include on-site computing resources 130, which may include all resources in a particular location (e.g., a building). For example, an organization may have an office with many general purpose computing resources, such as desktop computers, laptop computers, servers, and other types of computing resources as well. Each one of these resources may be a node into which a container and applications may be installed.

Resource pool 160 may also include off-site computing resources 140, such as remote computers, servers, etc. Off-site computing resources 140 may be connected to management system 100 by way of network connections, such as a wide area network connection (e.g., the Internet) or via a cellular data connection (e.g., LTE, 5G, etc.), or by any other data-capable network. Off-site computing resources 140 may also include third-party resources, such as cloud computing resource providers, in some cases. Such third-party services may be able to interact with management system 100 by way of API 126.

Nodes 132A, 132B, and 142A may be any sort of computing resource that is capable of having a container installed on it. For example, nodes 132A, 132B, and 142A may be desktop computers, laptop computers, tablet computers, servers, gaming consoles, or any other sort of computing device. In many cases, nodes 132A, 132B, and 142A will be general purpose computing devices.

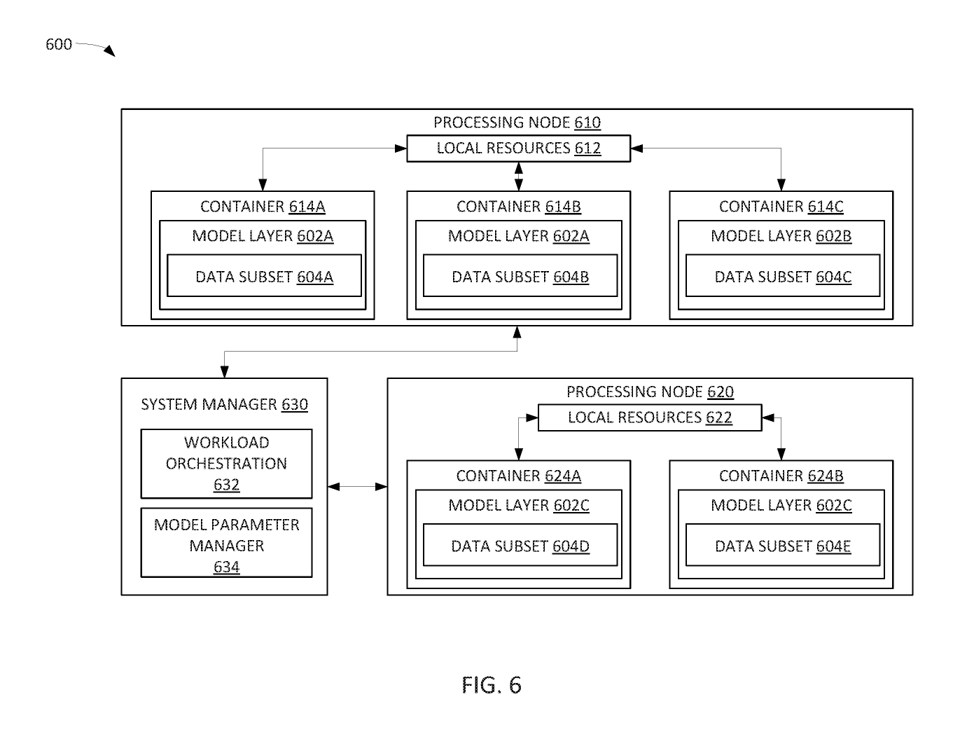

Management system 100 includes model repository 170. Model repository 170 includes model data 172, which may include data relating to trained models (including parameters), training data, validation data, model results, and others. Model repository 170 also includes training tools 174, which may include tools, SDKs, algorithms, hyperparameters, and other data related to training models, such as machine learning models, including neural network and deep learning models. Model repository 170 also includes model parameter manager 176, which interfaces with system manager to manage model parameters when system manager 108 has distributed model training across a plurality of nodes, such as nodes 132A, 132B, and 142A. Model parameter manager 176 will be discussed further below with respect to FIG. 6.

Management system 100 includes node state database 128, which stores information regarding nodes in resource pool 160, including, for example, hardware configurations and software configurations of each node, which may be referred to as static status information. Static status information may include configuration details such as CPU and GPU types, clock speed, memory size and type, disks available, network interface capability, firewall presence and settings, proxy and other server configuration (e.g., HTTP), presence and configuration of NTP servers, type and version of the operating system, applications installed on node, etc. In general, static status information comprises configuration information about a node that is not transient.

Node state database 128 may also store dynamic information regarding nodes in resource pool 160, such as the usage state of each node (e.g., power state, network connectivity speed and state, percentage of CPU and/or GPU usage, including usage of specific cores, percentage of memory usage, active network connections, active network requests, network status, network connections rate, service usages (e.g., SSH, VPN, DNS, etc.), networking usage (sockets, packets, errors, ICMP, TCP, UDP, explicit congestion notification, etc.), usage alerts and alarms, stats with quick refresh rate, synchronization, machine utilization, system temperatures, and machine learning analytics (e.g., using graphs, heat maps, and geological dashboards), availability of unused resources (e.g., for rent via a system marketplace), etc.). In general, dynamic status information comprises transient operational information about a node, though such information may be transformed into representative statistical data, such as averages (e.g., average percentage of CPU and/or GPU use, etc.).

In this example node state database 128 is shown separate from system manager 108, but in other embodiments node state database 128 may be another aspect of system manager 108.

Interface 150 provides a user interface for users to interact with system manager 108. For example, interface 150 may provide a graphical user interface (e.g., a dashboard) for users to schedule jobs, check the status of jobs, check the status of management system 100, configure management system 100, etc.

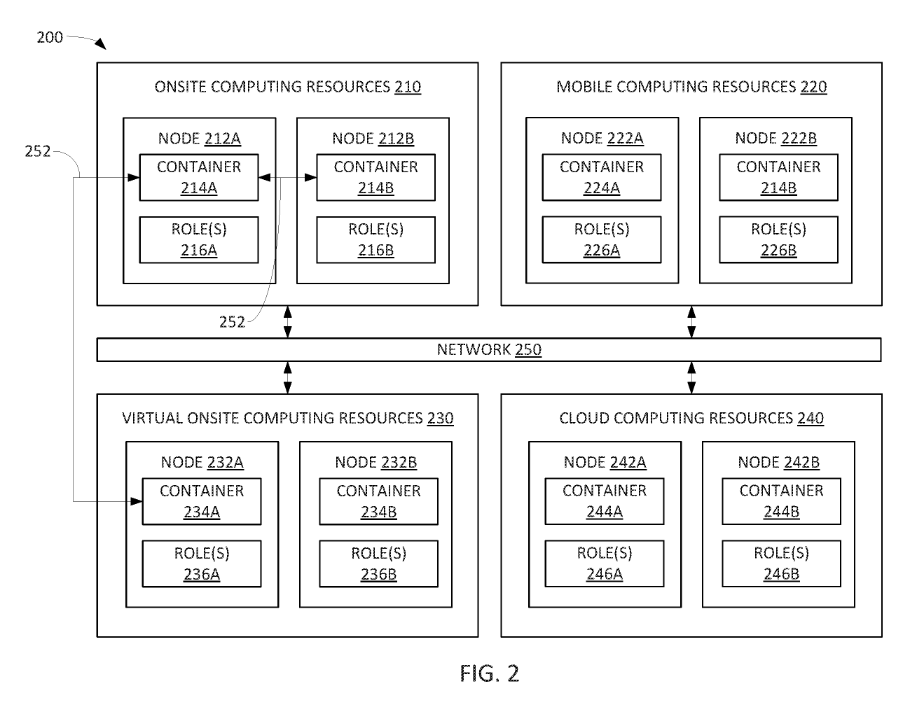

FIG. 2 depicts an example of a resource pool 200 of a heterogeneous distributed computing resource management system, such resource pool 160 in FIG. 1.

Resource pool 200 includes a number of resource sub-pools, such as on-site computing resources 210. As above, on-site resources may be resources at a particular site, such as in a particular building, or within a particular campus, or even on a particular floor. Generally speaking, on-site computing resources are collocated at a physical location and may be connected by a local area network (LAN). On-site computing resources may include any sort of computing resource found regularly in an organization's physical location, such as general purpose desktop and laptop computers, special purpose computers, servers, tablet computers, networking equipment (such as routers, switches, access points), or any other computing device that is capable of having a container installed so that its resources may be utilized to support a distributed computing system.

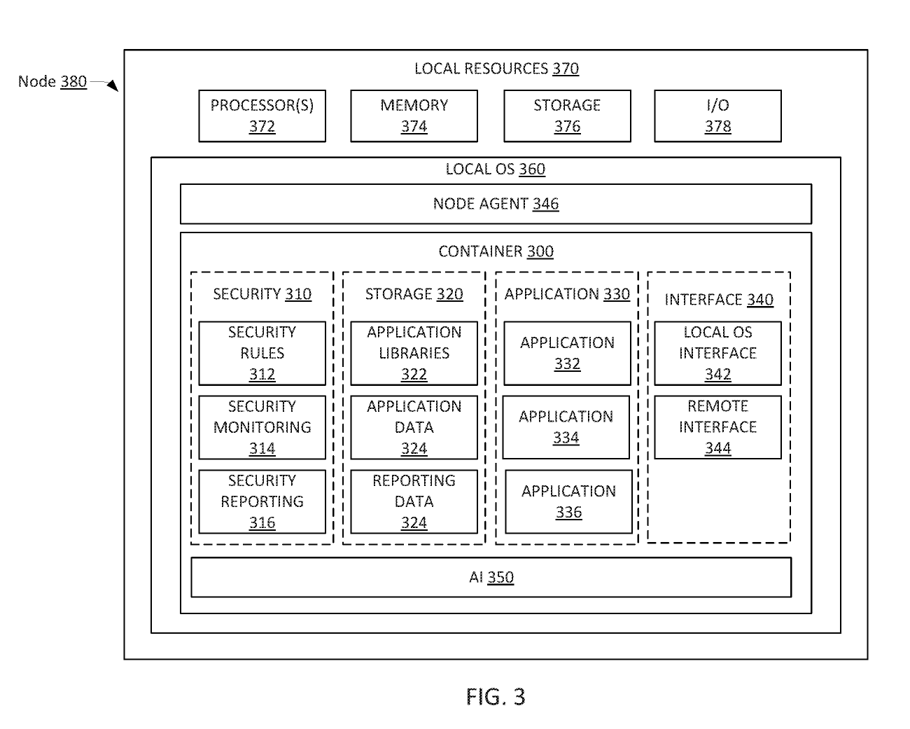

In this example, on-site computing resources 210 include nodes 212A and 212B, which include containers 214A and 214B, respectively. An example of a container will be described in more detail below with respect to FIG. 3.

Nodes 212A and 212B also include roles 216A and 216B, respectively. Roles 216A and 216B may be parameters or configurations provided to nodes 212A and 212B, respectively, during configuration (e.g., such as by node orchestration module 110 in FIG. 1). Roles 216 and 216B may configure the node for certain types of processing for a distributed computing system, such as a processing node role, a storage node role, a security node role, a monitoring node role, and others. In some cases, a node may be configured for a single role, while in other cases a node may be configured for multiple roles.

The roles configured for nodes may also be dynamic based on system needs. For example, a large processing job may call for dynamically shifting the roles of certain nodes to help manage the load of the processing job. In this way the nodes give the management system extensive flexibility to meet any number of use cases dynamically (i.e., without the need for inflexible, static configurations).

As shown with respect to nodes 212A and 212B, nodes may interact with each other (e.g., depicted by arrow 252) in a peer-to-peer fashion in addition to interacting with control elements of the distributed computing management system (e.g., as described with respect to FIG. 1).

On-site computing resources 210 are connected via network 250 to other computing resources, such as mobile computing resources 220, virtual on-site computing resources 230, and cloud computing resources 240. Each of these resource groups includes nodes, containers, and roles, as depicted in FIG. 2.

Mobile computing resources 220 may include devices such as portable computers (e.g., laptop computers and tablet computers), personal electronic devices (e.g., smartphones, smart-wearables), etc., which are not located (at least not permanently), for example, in an organization's office. For example, these types of portable computing resources may be used by users while travelling away from an organization's office.

Virtual on-site computing resources 230 may include, for example, nodes within virtual machines running on other computing resources. Thus, in some cases the network connection between the virtual on-site computing resources 230 and on-site computing resources 210 may be via a virtual network connection maintained by a virtual machine.

Cloud computing resources 240 may include, for example, third party services, such as AMAZON WEB SERVICES®, MICROSOFT AZURE®, and the like. These services may be able to interact with other nodes in the network through appropriate APIs, as discussed above with respect to FIG. 1.

As depicted in FIG. 2, nodes in different resource sub-pools may be configured to interact directly (e.g., in a peer-to-peer fashion), such as shown by line 252. In some cases, for example, a local node (e.g., node 212A) may have as one of its roles a local instance of a workload orchestrator. Thus, node 212A may help direct workloads as discussed above with respect to workload orchestration module 114 in FIG. 1. In other words, here node 212A may act as a local workload orchestrator for node 232A. Similarly, node 212A could have roles as a local node orchestrator, container orchestrator, application orchestrator, and the like.

Though FIG. 2 shows a single network 250 connecting all the types of computing resources, this is merely for convenience. There may be many different networks connecting the various computing resources. For example, mobile computing resources 220 may be connected by a cellular or satellite-based network connection, while cloud computing resources 240 may be connected via a wide area network connection.

FIG. 3 depicts an example of a container 300 as may be used in a heterogeneous distributed computing resource management system, such as system 100 in FIG. 1. Containers offer many advantages, such as isolation, extra security, simplified deployment and, most importantly, the ability to run non-native applications on a machine with a local operating system (e.g., running LINUX® apps on WINDOWS® machines).

As depicted, container 300 is resident within and interacts with a local operating system (OS) 360. In this example, container 300 includes a local OS interface 342, which may be configured based on the type of local OS 360 (e.g., a WINDOWS® interface, a MAC OS® interface, a LINUX® interface, or any other type of operating system). By interfacing with local OS 360, container 300 need not have its own operating system (like a virtual machine) and therefore container 300 may be significantly smaller in size as compared to a virtual machine. The ability for container 300 to be significantly smaller in installed footprint means that container 300 works more readily with a wide variety of computing resources, including those with relatively small storage spaces (e.g., certain types of mobile devices).

Container 300 includes several layers, including (in this example) security layer 310, storage layer 320, application layer 330, and interface layer 340.

Security layer 310 includes security rules 312, which may define local security policies for container 300. For example, security rules 312 may define the types of jobs container 300 is allowed to perform, the types of data container 300 is allowed to interact with, etc. In some cases, security rules 312 may be defined by and received from security module 122 as described with respect to FIG. 1, above. In some cases, the security rules 312 may be defined by an organization's STEM software as part of container 300 being installed on node 380.

Security layer 310 also includes security monitoring module 314, which may be configured to monitor activity related to container 300 as well as node 380. In some cases, security monitoring module 314 may be configured by, or under control of, security module 122 as described with respect to FIG. 1, above. For example, in some cases security monitoring module 314 may be a local instance of security module 122, which is capable of working with or without connection to management system 100, described with respect to FIG. 1, above. This configuration may be particularly useful where certain computing resources are not connected to outside networks for security reasons, such as in the case of secure compartmentalized information facilities (SCIFs).

Security layer 310 also includes security reporting module 316, which may be configured to provide regular, periodic reports of the security state of container 300, as well as event-based specific reports of security issues. For example, security reporting module 316 may report back to security module 122 (in FIG. 1) any condition of container 300, local OS 360, or node 380, which suggests a potential security issue, such as a breach of one of security rules 312.

In some cases, security layer 310 may interact with AI 350. For example, AI 350 may monitor activity patterns and flag potential security issues that would not otherwise be recognized by security rule 312. In this way, security layer 310 may be dynamic rather than static. As discussed above, in some cases AI 350 may be implemented using one or more machine learning models.

Container 300 also includes storage layer 320, which is configured to store data related to container 300. For example, storage layer 320 may include application libraries 322 related to applications installed within container 300 (e.g., applications 330). Storage layer 320 may also include application data 324, which may be produced by operation of applications 330. Storage layer 320 may also include reporting data 324, which may include data regarding the performance and activity of container 300.

Storage layer 320 is flexible in that the amount of storage needed by container 300 may vary based on current job loads and configurations. In this way, container 300's overall size need not be fixed and therefore need not waste space on node 380.

Notably, the components of storage layer 320 depicted in FIG. 3 are just one example, and many other types of data may be stored within storage layer 320.

Container 300 also includes application layer 330, which comprises applications 332, 334, and 336 loaded within container 300. Applications 332, 334, and 336 may perform a wide variety of processing tasks as assigned by, for example, workload orchestration module 114 of FIG. 1. In some cases, applications within application layer 330 may be configured by application orchestration module 116 of FIG. 1.

The number and type of applications loaded into container 300 may be based on one or more roles defined for container node 280, as described above with respect to FIG. 2. For example, one role may call for application 332 to be installed, and another role may call for applications 334 and 336 to be installed. As described above, because the roles assigned to a particular node (such as node 380) are dynamic, the number and type of applications installed within container 300 may likewise be dynamic.

Container 300 also includes interface layer 340, which is configured to give container 300 access to local resources of node 380 (e.g., by way of local OS interface 342) as well as to interface with a management system, such as management system 100 described above with respect to FIG. 1 (e.g., via remote interface 344).

Local OS interface module 342 enables container 300 to interact with local OS 360, which gives container 300 access to local resources 370. In this example, local resources 370 include one or more processors 372 (or cores within one or more processors 372), memory 374, storage 376, and I/O 378 of node 380. Processors 372 may include general purpose processors (e.g., CPUs), graphics processing units (e.g., GPUs), as well as special purpose processors (SPPUs), such as processors optimized for machine learning. Local resources 370 also include one or more memories 374 (e.g., volatile and non-volatile memories), one or more storages 376 (e.g., spinning or solid state storage devices), and I/O 378 (e.g., networking interfaces, display outputs, etc.).

Remote interface module 344 provides an interface with a management system, such as management system 100 described above with respect to FIG. 1. For example, container 300 may interact with container orchestration module 112, workload orchestration module 114, application orchestration module 116, and others of management system 100 by way of remote interface 344. As described in more detail below, remote interface module 344 may implement custom protocols for communicating with management system 100.

Container 300 includes a local AI 350. In some examples, AI 350 may be a local instance of AI module 118 described with respect to FIG. 1, while in others AI 350 may be an independent, container-specific AI. In some cases, AI 350 may exist as separate instances within each layer of container 300. For example, there may be an individual AI instance for security layer 310 (e.g., to help identify non-rule based security issues), storage layer 320 (e.g., to help analyze application data), application layer 330 (e.g., to help perform specific job tasks), and/or interface layer 340 (e.g., to interact with a system-wide AI).

A node agent 346 may be installed within local OS 360 (e.g., as an application or OS service) to interact with a management system, such as management system 100 described above with respect to FIG. 1. Examples of local OSes include MICROSOFT WINDOWS®, MAC OS®, LINUX®, and others.

Node agent 346 may be installed by a node orchestration module (such as node orchestration module 110 described with respect to FIG. 1) as part of initially setting up a node to work within a distributed computing system. When installing node agent 346 on certain operating systems, like MICROSOFT WINDOWS®, an existing software tool for remote software delivery, such as MICROSOFT® System Center Configuration Manager (SCCM), may be used to install node agent 346. In some cases, node agent 346 may be the first tool installed on node 380 prior to provisioning container 300.

Generally, node agent 346 is a non-virtualized, native application or service running as a non-elevated (e.g., user-level) resident process on each node. By not requiring elevated permissions, node agent 346 is easier to deploy in managed environments where permissions are tightly controlled. Further, running node agent 346 as a non-elevated user-level protects user experience because it avoids messages or prompts, which require user attention, such as WINDOWS® User Account Control (UAC) pop-ups.

Node agent 346 may function as an intermediary between the management system and container 300 for certain functions. Node agent 346 may be configured to control aspects of container 300, for example, enabling the running of applications (e.g., applications 332, 334, and 336), or even the enabling or disabling of container 300 entirely.

Node agent 346 may provide node status information to the management system, e.g., by querying the local resources 370. The status information may include, for example, CPU and GPU types, clock speed, memory size, type and version of the operating system, etc.

Node agent 346 may also provide container status information, e.g., by querying container 300 via local OS interface 342.

Notably, node agent 346 may not be necessary on all nodes. Rather, node agent 346 may be installed where necessary to interact with operating systems that are not inherently designed to host distributed computing tools, such as container 300, and to participate in heterogeneous distributed computing environments, such as described with respect to FIG. 1.

### Example Method Performed by a Heterogeneous Distributed Computing Resource Management System

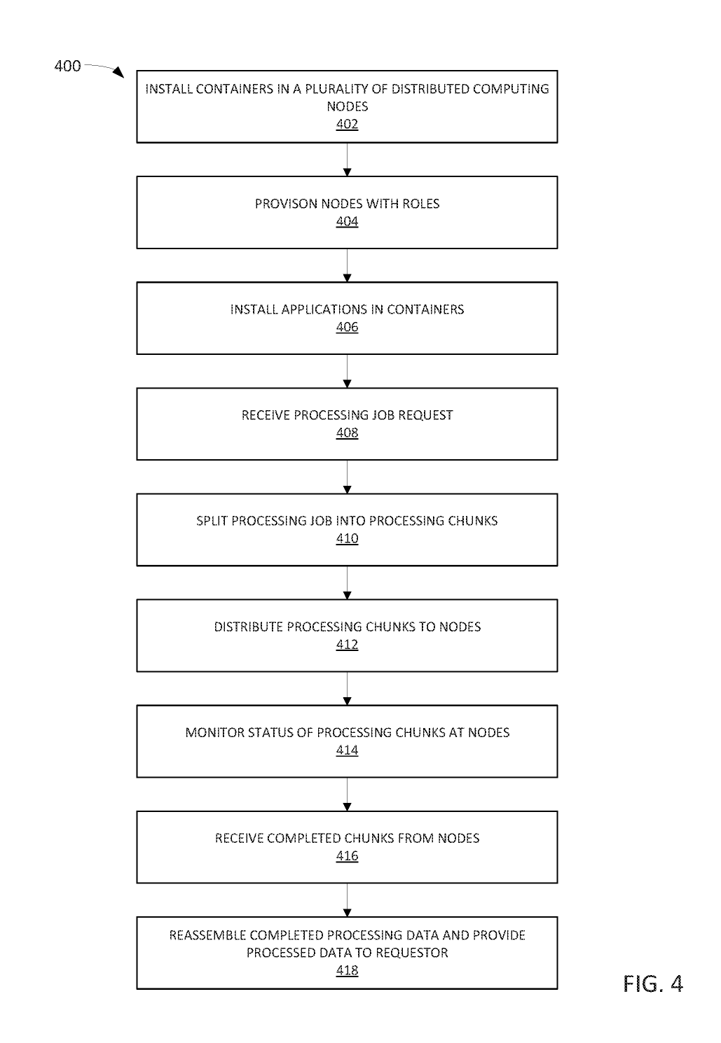

FIG. 4 depicts an example method 400 that may be performed by a heterogeneous distributed computing resource management system, such as system 100 in FIG. 1.

Method 400 begins at step 402 where a plurality of containers, such as container 300 described with respect to FIG. 3, are installed in a plurality of distributed computing nodes. For example, the nodes could be in a resource pool including one or more resource sub-pools, as described with respect to FIG. 2. In some examples, container orchestration module 112 of FIG. 1 may perform the installation of the containers at the plurality of nodes.

The method 400 then proceeds to step 404 where the nodes are provisioned with roles, for example, as described above with respect to FIG. 2. In some cases, nodes may be provisioned with more than one role. In some examples, node orchestration module 110 of FIG. 1 may perform the provisioning of roles to the nodes.

The method 400 then proceeds to step 406 where applications are installed in containers at each of the nodes. In some examples, the applications are pre-installed based on the provisioned roles. In other cases, applications may be installed on-demand based on processing jobs handled by the nodes. For example, applications may be installed and managed by application orchestration module 116, as described above with respect to FIG. 1.

The method 400 then proceeds to step 408, where a processing job request is received. For example, a request may be received from a user of the system via interface 150 of FIG. 1. The job request may be for any sort of processing that may be performed by a distributed computing system. For example, the request may be to transcode a video file from one format to another format.

In some examples, the job request may include parameters associated with the processing job, such as the maximum amount of time acceptable to complete the processing job. Such parameters may be considered by, for example, workload orchestration node 114 of FIG. 1 to determine the appropriate computing resources to allocate to the requested processing job. Another parameter may be associated with the types of computing resources that may be used to complete the job. For example, the request may require that only on-site computing resources can be utilized due to security considerations.

The method 400 then proceeds to step 410 where the processing job is split into chunks. The chunks are portions of the processing job (i.e., sub-jobs, sub-tasks, etc.) that may be handled by different processing nodes so that the processing job may be handled in parallel and thus more quickly. In some examples, the processing job may not be split into chunks if the characteristics of the job do not call for it. For example, if the processing job is extremely small or low priority, it may be kept whole and distributed to a single processing node.

The method 400 then proceeds to step 412 where the chunks are distributed to nodes. In some examples, workload orchestration module 114 of FIG. 1 coordinates the distribution of the chunks. Further, in some examples, AI module 118 of FIG. 1 may work in concert with workload orchestration module 114 in order to distribute the chunks according to a predicted maximum efficiency allocation.

The chunks may be distributed to different nodes in a distributed computing resource system based on many different factors. For example, a node may be chosen for a chunk based on characteristics of the nodes, such as the number or type of processors in the node, or the applications installed at the nodes (e.g., as discussed with respect to FIG. 3), etc. Using the example above of a video transcoding job, it may be preferable to distribute the chunks to nodes that include special purpose processors, such as powerful GPUs, which can process the chunks very efficiently.

A node may also be chosen based on current resource utilizations at the node. For example, if a node is currently heavily utilized by normal activity (such as a personal workstation) or by other processing tasks associated with the distributed computing resource system, it may not be selected for distribution of the chunk.

A node may also be chosen based on scheduled availability of the node. For example, a node that is not scheduled for system availability for several hours may not be chosen while a node that is scheduled for system availability may be preferred. In some cases, where for example the percentage of available processing utilization available at a node is based on schedules, the system may calculate the relative availability of nodes taking into account the schedule constraints.

A node may also be chosen based on network conditions at the node. For example, if a mobile processing node (e.g., a laptop computer) is connected via a relatively lower speed connection (e.g., a cellular connection), it may not be preferred where another node with a faster connection is available. Notably, these are just a few examples of the type of logic that may be used for distributing the chunks to nodes in the distributed computing resource system.

In some examples, one or more of the chunks may be distributed to more than one node such that redundant, parallel processing of various chunks is undertaken. Such a strategy may be based, for example, on an AI prediction that certain nodes may go offline during the processing, or simply to try and maximize the speed of the processing. In other words, where a particular chunk is distributed to more than one node, the first node that finishes the chunk may report the same to the distributed computing resource management system and then the redundant processing may be stopped. In this way, the maximum speed of processing the chunks may be obtained. Thus, using the example above, an individual chunk of a video file to be transcoded may be distributed to multiple processing nodes in an effort to get the best performance where a priori knowledge of the time for processing at each node is not known for sure.

The method 400 then proceeds to step 414 where the status of the processing of the chunks is monitored at the various nodes. For example, monitoring module 124 of FIG. 1 may receive monitoring information from the various nodes as they process the chunks. Information may also be received from workload orchestration module 114 of FIG. 1, which may be managing the processing nodes associated processing job.

In some cases, during step 414 a node may go offline or experience some other sort of performance problem, such as loss of resource availability. In such cases, a chunk may be reassigned to another node in order to maintain the overall progress of the processing job. The monitoring of processing status may also be fed to an AI (e.g., AI module 118 in FIG. 1) in order to train the system as to which nodes are faster, more reliable, etc. Using the feedback from the monitoring, AI module 118 may learn over time to distribute certain types of processing jobs to different nodes, or to distribute chunks in particular manners amongst the available nodes to maximize system performance.

The method 400 then proceeds to step 416 where processed chunks are received from the nodes to which the chunks were originally distributed. For example, workload orchestration module 114 of FIG. 1 may receive the processed chunks.

Though not depicted in FIG. 4, the management system may record performance statistics of each completed processing job. The performance statistics may be used, for example, by an AI (e.g., AI module 118 of FIG. 1) to affect the way a workload orchestration module (e.g., workload orchestration module 114 of FIG. 1) allocates processing jobs or manages processing of jobs.

The method 400 then proceeds to step 418 where the processed chunks are reassembled into a completed processing job and provided to a requestor. Using the example above, the transcoded chunks of the video file may be reassembled into a single, transcoded video file ready for consumption.

In the event any chunks of the original video file were distributed to more than one node for processing, those nodes may be instructed to cease any unfinished processing (e.g., via workload orchestration module 114 of FIG. 1) and to delete the in-progress processing data.

Notably, the steps of method 400 described above are just some examples. In other embodiments, some of the steps may be omitted, additional steps may be added, or the order of the steps may be altered. Method 400 is described for illustrative purposes and is not indicative of the total range of capabilities of, for example, management system 100 of FIG. 1.

### Example Approaches to Distributing Model Training

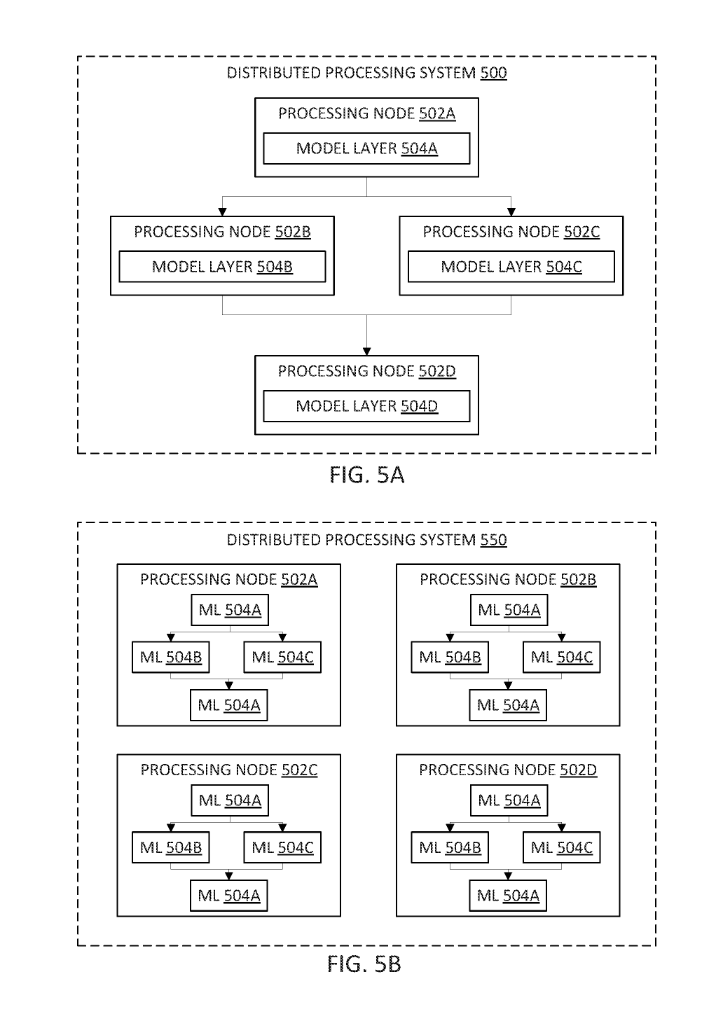

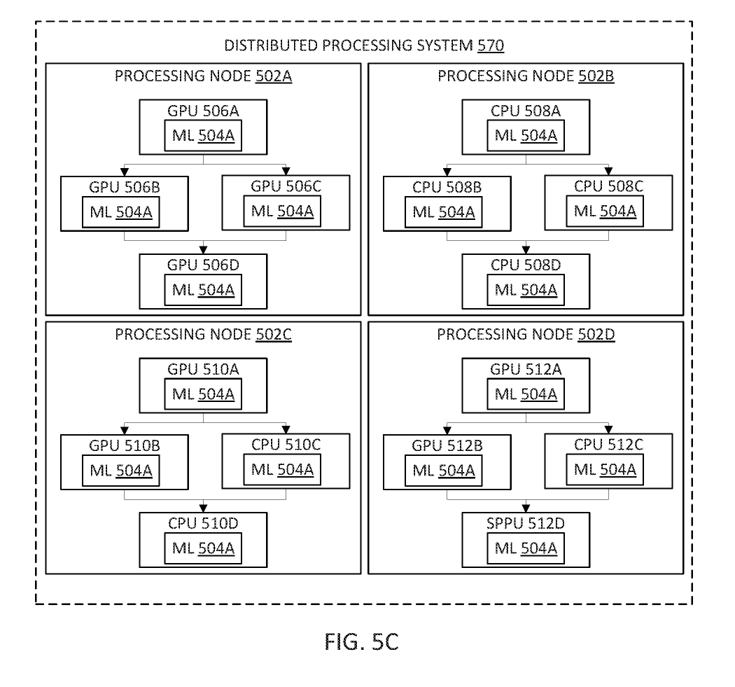

FIGS. 5A and 5B depict two different approaches to distributed training of machine learning models, which is just one example of the types of distributed processing described above.

FIG. 5A depicts an example of model parallelism when training a machine learning model. In this example, processing nodes 502A-D of distributed system 500 are responsible for computations of different parts of a single machine learning model (in this example, a neural network model). For example, each layer 504A-D in a neural network is assigned to a different processing node, here 502A-D, respectively. The neural network is then constructed from layers 504A-D that are each processed on the different processing nodes, 502A-D. In this way, the training of different aspects (e.g., different parameters) of complex models happens in parallel, which allows the training process to leverage the power of multiple processing nodes at once, rather than relying on a single processing node as in conventional approaches.

FIG. 5B depicts an example of data parallelism when training a machine learning model. In this example, processing nodes 502A-D in distributed system 550 each train a complete copy of the machine learning model (in this example, a neural network), including layers 504A-D, but each processing node gets a different portion of the training data to process. In this way, large training data sets can be efficiently processed in parallel across different processing nodes.

In the case of data parallelism, the results from each processing node 502A-D (e.g., parameter values) may be combined to generate the final parameters for the model (e.g., the resulting trained neural network model). For example, parameter averaging between processing nodes 502A-D may be employed. With parameter averaging, training the neural network may proceed with: (1) initializing the model parameters randomly based on the model configuration; (2) distributing a copy of the current parameters to processing node 502A-D; (3) training each processing node 502A-D on a subset of the data; (4) and setting the global parameters to the average the parameters from processing node 502A-D. Other methods for combining results include synchronous and asynchronous gradient descent methods, among others.

FIG. 5C depicts a hybrid model parallelism/data parallelism approach in which the entire model is distributed to each of processing nodes 502A-D, but within each respective processing node, the layers of the model 504A-D are trained by distinct processing hardware of the respective processing node.

For example, in the case of processing node 502A, graphical processing units (GPUs) 506A-506D are each tasked with training a particular layer of the model, 504A-D, respectively. In the case of processing node 502B, central processing units (CPUs) 506A-506D are each tasked with training a particular layer of the model, 504A-D, respectively. In the case of processing node 502C, a mixture of GPUs 510A-B and CPUs 510C-D are each tasked with training a particular layer of the model, 504A-D, respectively. Finally, in the case of processing node 502D, a mixture of GPUs 510A-B and CPU 510C, and a special purpose processing unit (SPPU) 512D are each tasked with training a particular layer of the model, 504A-D, respectively. SPPU 512D may be a processor optimized for machine learning processing, such as for training machine learning models.

The specific hardware/layer pairings depicted in FIG. 5C (e.g., of CPUs, GPUs, and SPPUs) are exemplary and meant only to show a few of the many configurations possible with modern processing architectures. For example, the pairings could become even more granular, such as by assigning one model or one data set to a particular core within a processing unit, such as a CPU, GPU, or SPPU.

FIG. 6 depicts aspects of a distributed computing system 600 configured for distributed training of machine learning models.

In particular, FIG. 6 depicts a system manager 630, which may be like system manager 108 described above with respect to FIG. 1, coordinating the training of a machine learning model between processing nodes 610 and 620.

In this example, model parallelism and data parallelism are employed in a hybrid fashion with the additional feature of containerization. The use of containers significantly improves the versatility of system 600 for a variety of reasons. First, using containers allows processing nodes to run different types of applications than may be available on their local operating systems. For example, LINUX® applications may be run on WINDOWS®-based processing nodes using containers. Second, the containers allow more granular control over processing nodes' local resources. For example, whereas a local OS may not allow for controlling processing tasks on a per-processor or even per-core basis, the containers may be allow more granular divisions of physical processing resources within the processing nodes. Third, containers allow a single machine to act as multiple machines by processing data within containers in parallel, whereas the local OS may always schedule the processing in series. These are just a few examples, and many additional benefits exist.

Notably, data parallelism and model parallelism may be employed within a single processing node using containers. For example, processing node 610 includes both containers associated with multiple layers of a model (e.g., container 614A is associated with model layer 602A, while container 614C is associated with model layer 602B), as well as containers associated with multiple data subsets (e.g., container 614A is associated with model layer 602A and data subset 604A, while container 614B is also associated with model layer 602A, but with data subset 604B). Note that while processing node 610 includes a different data subset within each of containers 614A-C, this need not be the case. That is, more than one container could use the same data subset for the same model layer or for different model layers. FIG. 6 only depicts a few of the possible combinations for simplicity.

Processing node 620 includes two different containers 624A-B, which are both configured to train model layer 602C, but on different data subsets (data subset 604D for container 624A and data subset 604E for container 624B. Notably, processing node 620 has fewer containers as compared to processing node 610. This may reflect a disparity in overall processing power, average available processing power, total memory space, average available memory space, types of processing hardware (e.g., CPUs, GPUs, and SPPUs), and other characteristics that may have been considered by a container orchestration module (e.g., container orchestration module 112 in FIG. 1) when first setting up containers 624A and 624B.

As with processing node 610, processing node 620 has local resource 622 that the local containers (here, 624A and 624B) interact with. In some implementations, each container may be assigned to a specific one or more processing resources, such as one or more CPUs, GPUs, SPPUs, or cores within any type of processing units. Further, each container may be assigned to other resources, such as memory resources (logical or physical), or networking resources (logical or physical). For example, a certain amount of available RAM may be reserved for a container and a certain network adapter may likewise be reserved or otherwise prioritize a container. In this way, not only can the local resources of processing nodes 610 and 620 be utilized optimally, but resources needed for general purpose processing can be reserved so that the processing nodes can continue to perform their ordinary purpose.

In some cases, a container orchestration module may configure containers on various processing nodes (e.g., 610 and 620) based on characteristics of a model training request or configuration (as may be provided via interface 150 in FIG. 1). For example, depending on the number of parameters, amount of data to be processed, etc., the container orchestration may choose an optimal configuration of containers. In some examples, a monitoring module (e.g., monitoring module 124 in FIG. 1) may monitor performance of model training processing and work with an AI (e.g., AI module 118 in FIG. 1) to optimize the configuration of containers on available processing nodes.

The configuration of the containers in FIG. 6 in terms of model layers and data subsets is just one example, and model and data parallelism (such as described with respect to FIGS. 5A-5C) may be used in different ways within and among containers on processing nodes. For example, while not depicted in FIG. 6, one container may include all of the layers of a given model, while others may only include a subset of the model layers. In FIG. 6, only one model layer is depicted in each container as a convenient example, and not a limitation on the architecture. Similarly, a single container within a processing node may be tasked with processing one or more data subsets, or an entire data set. Again, while the containers in FIG. 6 are shown as only processing a single data subset, this is merely one example and not a limitation of the architecture.

The distributed fashion of the containerized data processing (e.g., the model training in this example) depicted in FIG. 6 allows for a robust and fault tolerant system. For example, if processing node 620 were to go offline, the relatively smaller processing tasks associated with model layer 602C and data subsets 604D and 604E may be quickly rebuilt or instantiated in another available processing node.

Workload orchestration module 632, which may be like workload orchestration module 114 described above with respect to FIG. 1, coordinates processing tasks between processing nodes 610 and 620 and their respective containers. Note that while not shown in FIG. 6, containers 614A-C and 624A-B may be configured by a container orchestration module, such as 112 in FIG. 1. From the perspective of workload orchestration module 114, each container may appear as an independent resource, regardless of processing node location, though system manager 630 will be aware of local resources 612 and 622 in each of processing nodes 610 and 620, respectively, as well as how those local resources are associated with or otherwise made available to containers 614A-C and 624A-B.

Model parameter manager 634, which may be like model parameter manager 176 of FIG. 1, manages the parameter data being generated by the distributed training on processing nodes 610 and 620. For example, as described above, because the training is distributed, the results of the distributed (e.g., partial) training must be combined to give a final result.

Model parameter manager 634 may utilize many different methods for combining model parameter data from the containers (e.g., 614A-C and 624A-B) within the processing nodes (e.g., 610 and 620). For example, as discussed above, parameter averaging can be used. Alternatively, descent based methods can be used, such as gradient descent methods. Any of the methods may be run in a synchronized fashion, such as where every container finishes a training epoch before any container moves onto the next training epoch, or in an asynchronous fashion, where containers may finish processing epochs at different rates. After each training epoch, a plurality of parameter data is sent back to model parameter manager 634 for combining. The parameter data created after each epoch may be referred to as partial parameter data, delta parameter data, iterative parameter data, or the like.

Model parameter manager 634 may also manage hyperparameters, for example received from a user interface, such as user interface 150 in FIG. 1. For example, model parameter manager 634 may store hyperparameter settings and provide them to containers (e.g., 614A-C and 624A-B) for model training-related data processing.

System 600 may be particularly suited for training neural networks and for performing deep learning as it can scale with the size of the processing demands of the model and it can take advantage of granular information available regarding each processing node's capabilities.

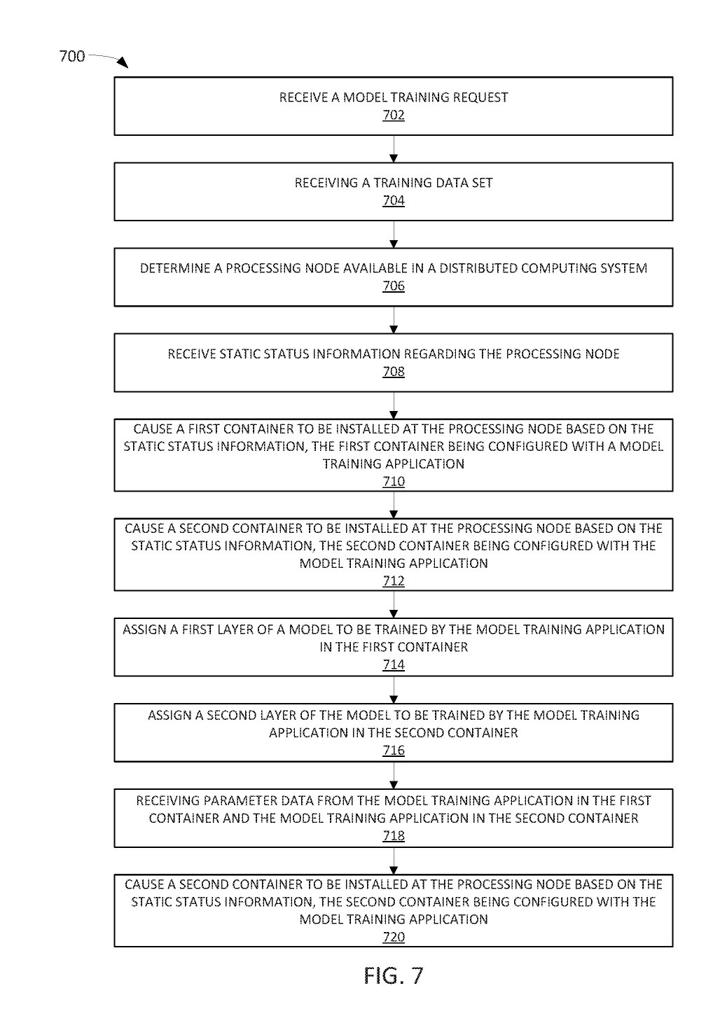

FIG. 7 depicts a method 700 for training a machine learning model in a distributed computing system.

Method 700 beings at step 702 with receiving a model training request. For example, the model training request may be received from a user interface, such as user interface 150 in FIG. 1. In some implementations, the model training request may include parameters related to the model, such as hyperparameters, defined inputs or features, a defined output type or output classes, a type of model, and others. The model training request may include parameters related to training a neural network model or a deep learning model. For example, the model training request may define gradient descent hyperparameters, such as learning rate, loss function, mini-batch size, number of training iterations, momentum, etc. Further, the model training request may define model hyperparameters, such as number of hidden nodes, weight decay, activation sparsity, nonlinearity, weight initialization, random seeds and model averaging, and preprocessing input data. As yet another example, the model training request may define hyperparameters related to parameter space exploration, including coordinate descent, grid search, random search, and model-based optimization methods.

Method 700 then proceeds to step 704 with receiving a training data set. The training data set may include data to be used for the model requested in step 702. In some cases, the training data set may be partitioned into subsets of training data, which may be distributed to different processing nodes, and in particular, different containers within different processing nodes. The data subsets may relate to the whole model, or different aspects of the model, such as different parameters of the model. In some cases, the training data may also include validation data that may be used to test and validate the model after training.

Method 700 then proceeds to step 706 determining a processing node available in a distributed computing system. For example, a node orchestration module such as described with respect to FIG. 1 may determine which nodes in the distributed computing system are available. In some examples, the availability of the processing node may be based on one or more criteria or filters applied to all available processing nodes in the distributed computing system.

Method 700 then proceeds to step 708 with receiving static status information regarding the processing node. As described above, static status information may include hardware configuration and software configuration information regarding the processing node.

Method 700 then proceeds to step 710 with causing a first container to be installed at the processing node based on the static status information, the first container being configured with a model training application. In some implementations, a container orchestration module such as described with respect to FIG. 1 orchestrates the installation of the container at the processing node. In some cases, the container is preconfigured with one or more applications, including the model training application. For example, the model training application may be one of the applications stored in application repository 102 of FIG. 1. Further, a node agent as described with respect to FIG. 3 may also be involved with the installation of the container at the processing node.

Method 700 then proceeds to step 712 with causing a second container to be installed at the processing node based on the static status information, the second container being configured with the model training application. As above, in some implementations a container orchestration module may orchestrate the installation of the container.

Though not depicted in FIG. 7 with respect to method 700, in other implementations of the method, containers may not need to be installed on some or all of the nodes used for distributed learning. Rather, existing containers on processing nodes may be used. In such implementations, the determination of available processing nodes in step 706 may include determining one or more available containers within any available processing nodes.

Method 700 then proceeds to step 714 with assigning a first layer of a model to be trained by the model training application in the first container. For example, a first layer of a model, such as a neural network or other deep learning model, may be assigned to the first container by way of a workload orchestration module, such as described with respect to FIGS. 1 and 6. As described above, the first container is not limited to having a single layer, and in other examples, multiple layers may be assigned to the first container.

Method 700 then proceeds to step 716 with assigning a second layer of the model to be trained by the model training application in the second container. As above, a workload orchestration module may assign one or more layers to the second container. As described above with respect to FIG. 6, different one or more different model layers may be assigned to different containers in order to implement model parallelism when training the model in the distributed computing environment.

Method 700 then proceeds to step 718 with receiving parameter data from the model training application in the first container and the model training application in the second container. For example, the parameter data may be received by a model parameter manager, such as described above with respect to FIG. 6.

Method 700 then proceeds to step 720 with calculating a model parameter based on the parameter data. In some implementations, calculating the model parameter is based on the parameter data comprises applying a parameter averaging method to the parameter data. In other implementations, calculating the model parameter is based on the parameter data comprises applying a gradient descent method to the parameter data.

Though not shown in FIG. 7, method 700 may further include assigning a first data subset to the model training application in the first container and assigning a second data subset to the model training application in the second container. For example, as described above with respect to FIG. 6, different data subsets may be assigned to different containers in order to implement data parallelism when training the model in the distributed computing environment.

In other implementations, method 800 may further include assigning a first data subset to the model training application in the first container; and assigning the first data subset to the model training application in the second container. In such cases, redundancy may be valued over speed.

Method 700 may further include causing a third container to be installed at the processing node based on the static status information, the third container being configured with the model training application; and assigning the first layer and the second layer to be trained by the model training application in the third container. As above, any number of layers and data subsets may be assigned to different containers on different processing nodes.

In some implementations, the processing node comprises a local operating system, and the model training application is configured to run on an operating system different from the local operating system. For example, the local operating may be MICROSOFT WINDOWS® while the application is configured to run on LINUX, or another operating system.

Notably, method 700 is just one example, and other embodiments of methods include more or fewer steps consistent with the description herein.

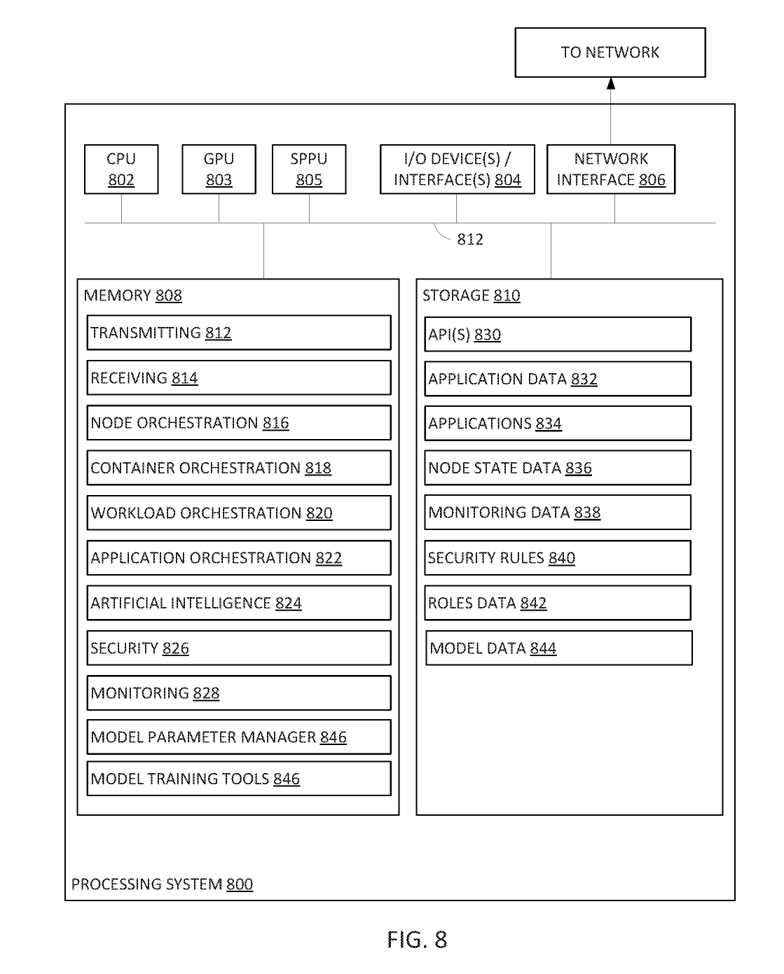

FIG. 8 depicts a processing system 800 that may be used to perform methods described herein, such as the method for managing distributed computing resource described above with respect to FIG. 4 and the method for training a machine learning model in a distributed computing system with respect to FIG. 7.

Processing system 800 includes a CPU 802, GPU 803, and SPPU 805 all connected to a data bus 812. CPU 802, GPU 803, and SPPU 805 are configured to process computer-executable instructions, e.g., stored in memory 808 or storage 810, and to cause processing system 800 to perform methods as described herein, for example with respect to FIGS. 4 and 7. Though depicted as only including only one CPU 802, GPU 803, and SPPU 805, processing system 800 may have more than one of each type of processor. Further, in some implementations, processing system 800 may not have each type of processing unit. For example, another implementation of processing system 800 may only include CPU 802 and GPU 803. FIG. 8 is merely one example of a processing unit configured to execute the methods described herein.

Processing system 800 further includes input/output device(s) and interface(s) 804, which allows processing system 800 to interface with input/output devices, such as, for example, keyboards, displays, mouse devices, pen input, and other devices that allow for interaction with processing system 800. Note that while not depicted with independent external I/O devices, processing system 800 may connect with external I/O devices through physical and wireless connections (e.g., an external display device).

Processing system 800 further includes network interface 806, which provides processing system 800 with access to external networks and thereby external computing devices.

Processing system 800 further includes memory 808, which in this example includes transmitting component 812 and receiving component 814, which may perform transmitting and receiving functions as described above with respect to FIGS. 1-7.

Memory 808 further includes node orchestration component 816, which may perform node orchestrations functions as described above with respect to FIGS. 1-7.

Memory 808 further includes container orchestration component 818, which may perform container orchestrations functions as described above with respect to FIGS. 1-7.

Memory 808 further includes workload orchestration component 820, which may perform workload orchestrations functions as described above with respect to FIGS. 1-7.

Memory 808 further includes node application component 822, which may perform application orchestrations functions as described above with respect to FIGS. 1-7.

Memory 808 further includes node artificial intelligence (AI) 824, which may perform AI functions as described above with respect to FIGS. 1-7.

Memory 808 further includes security component 826, which may perform security functions as described above with respect to FIGS. 1-7.

Memory 808 further monitoring component 828, which may perform monitoring functions as described above with respect to FIGS. 1-7.

Memory 808 further monitoring component 828, which may perform monitoring functions as described above with respect to FIGS. 1-7.

Memory 808 further model parameter manager 846, which may perform model parameter managing functions as described above with respect to FIGS. 1-7.

Memory 808 further model parameter manager 848, which may perform model training functions as described above with respect to FIGS. 1-7.

Note that while shown as a single memory 808 in FIG. 8 for simplicity, the various aspects stored in memory 808 may be stored in different physical memories, but all accessible CPU 802 via internal data connections, such as bus 812, or external data connections, such as network interface 806 or I/O device interfaces 804.

Processing system 800 further includes storage 810, which in this example includes application programming interface (API) data 830, such as described above with respect to FIGS. 1-7.

Storage 810 further includes application data 832, such as described above with respect to FIGS. 1-7.

Storage 810 further includes applications 834 (e.g., installation files, binaries, libraries, etc.), such as described above with respect to FIGS. 1-7.

Storage 810 further includes node state data 836, such as described above with respect to FIGS. 1-7.

Storage 810 further includes monitoring data 838, such as described above with respect to FIGS. 1-7.

Storage 810 further includes security rules 840, such as described above with respect to FIGS. 1-7.

Storage 810 further includes roles data 842, such as described above with respect to FIGS. 1-7.

Storage 810 further includes model data 844, such as described above with respect to FIGS. 1-7.

While not depicted in FIG. 8, other aspects may be included in storage 810.

As with memory 808, a single storage 810 is depicted in FIG. 8 for simplicity, but the various aspects stored in storage 810 may be stored in different physical storages, but all accessible to CPU 802 via internal data connections, such as bus 812, I/O interfaces 804, or external connection, such as network interface 806.

The preceding description provides examples, and is not limiting of the scope, applicability, or embodiments set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The preceding description is provided to enable any person skilled in the art to practice the various embodiments described herein. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

A processing system may be implemented with a bus architecture. The bus may include any number of interconnecting buses and bridges depending on the specific application of the processing system and the overall design constraints. The bus may link together various circuits including a processor, machine-readable media, and input/output devices, among others. A user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer-readable medium. Software shall be construed broadly to mean instructions, data, or any combination thereof, whether referred to as software, firmware, middleware, microcode, hardware description language, or otherwise. Computer-readable media include both computer storage media and communication media, such as any medium that facilitates transfer of a computer program from one place to another. The processor may be responsible for managing the bus and general processing, including the execution of software modules stored on the computer-readable storage media. A computer-readable storage medium may be coupled to a processor such that the processor can read information from, and write information to, the storage medium. In the alternative, the storage medium may be integral to the processor. By way of example, the computer-readable media may include a transmission line, a carrier wave modulated by data, and/or a computer readable storage medium with instructions stored thereon separate from the wireless node, all of which may be accessed by the processor through the bus interface. Alternatively, or in addition, the computer-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module, it will be understood that such functionality is implemented by the processor when executing instructions from that software module.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method for training a machine learning model in a distributed computing system:
receiving a model training request;
receiving a training data set;
determining a processing node available in a distributed computing system;
receiving static status information regarding the processing node;
causing a first container to be installed at the processing node based on the static status information, the first container being configured with a model training application;
causing a second container to be installed at the processing node based on the static status information, the second container being configured with the model training application;
assigning a first layer of a model to be trained by the model training application in the first container;
assigning a second layer of the model to be trained by the model training application in the second container;
receiving parameter data from the model training application in the first container, the model training application in the second container, and the model training application in the third container; and
calculating a model parameter based on the parameter data.

2. The method of claim 1, further comprising:
assigning a first data subset to the model training application in the first container; and
assigning a second data subset to the model training application in the second container.

3. The method of claim 1, further comprising:
assigning a first data subset to the model training application in the first container; and
assigning the first data subset to the model training application in the second container.

4. The method of claim 1, further comprising:
causing a third container to be installed at the processing node based on the static status information, the third container being configured with the model training application;
assigning the first layer and the second layer to be trained by the model training application in the third container; and
receiving parameter data from the model training application in the third container.

5. The method of claim 1, wherein:
the processing node comprises a local operating system, and
the model training application is configured to run on an operating system different from the local operating system.

6. The method of claim 5, wherein the local operating is MICROSOFT WINDOWS®.

7. The method of claim 6, wherein the application is configured to run on LINUX.

8. The method of claim 1, wherein calculating the model parameter based on the parameter data comprises applying a parameter averaging method to the parameter data.

9. The method of claim 1, wherein calculating the model parameter based on the parameter data comprises applying a gradient descent method to the parameter data.

10. An apparatus for managing deployment of distributed computing resources, comprising:
a memory comprising computer-executable instructions; and
a processor in data communication with the memory and configured to execute the computer-executable instructions and cause the apparatus to perform a method for training a machine learning model in a distributed computing system, the method comprising:
receiving a model training request;
receiving a training data set;
determining a processing node available in a distributed computing system;
receiving static status information regarding the processing node;
causing a first container to be installed at the processing node based on the static status information, the first container being configured with a model training application;
causing a second container to be installed at the processing node based on the static status information, the second container being configured with the model training application;
assigning a first layer of a model to be trained by the model training application in the first container;
assigning a second layer of the model to be trained by the model training application in the second container;
receiving parameter data from the model training application in the first container and the model training application in the second container; and
calculating a model parameter based on the parameter data.

11. The apparatus of claim 10, wherein the method further comprises:
assigning a first data subset to the model training application in the first container; and
assigning a second data subset to the model training application in the second container.

12. The apparatus of claim 10, wherein the method further comprises:
assigning a first data subset to the model training application in the first container; and
assigning the first data subset to the model training application in the second container.

13. The apparatus of claim 10, wherein the method further comprises:
causing a third container to be installed at the processing node based on the static status information, the third container being configured with the model training application;
assigning the first layer and the second layer to be trained by the model training application in the third container; and
receiving parameter data from the model training application in the third container.

14. The apparatus of claim 10, wherein:
the processing node comprises a local operating system, and
the model training application is configured to run on an operating system different from the local operating system.

15. The apparatus of claim 14, wherein the local operating is MICROSOFT WINDOWS®.

16. The apparatus of claim 15, wherein the application is configured to run on LINUX.

17. The apparatus of claim 10, wherein calculating the model parameter based on the parameter data comprises applying a parameter averaging method to the parameter data.

18. The apparatus of claim 10, wherein calculating the model parameter based on the parameter data comprises applying a gradient descent method to the parameter data.

19. A non-transitory computer-readable medium comprising instructions for performing a method for training a machine learning model in a distributed computing system, the method comprising:
receiving a model training request;
receiving a training data set;
determining a processing node available in a distributed computing system;
receiving static status information regarding the processing node;
causing a first container to be installed at the processing node based on the static status information, the first container being configured with a model training application;
causing a second container to be installed at the processing node based on the static status information, the second container being configured with the model training application;
assigning a first layer of a model to be trained by the model training application in the first container;
assigning a second layer of the model to be trained by the model training application in the second container;
receiving parameter data from the model training application in the first container, the model training application in the second container, and the model training application in the third container; and
calculating a model parameter based on the parameter data.

20. The non-transitory computer-readable medium of claim 19, wherein:
the processing node comprises a local operating system, and
the model training application is configured to run on an operating system different from the local operating system.
